(19) United States
(12) Patent Application Publication
(10) Pub. No.: US 2012/0227329 A1
(43) Pub. Date: Sep. 13, 2012

(54) REVERSIBLE SLIDING GLASS DOOR

(76) Inventor: Mary Lou Vosburg, Las Vegas, NV (US)

(21) Appl. No.: 13/349,420

(22) Filed: Jan. 12, 2012

Related U.S. Application Data
(63) Continuation of application No. 12/387,739, filed on May 8, 2009, now abandoned.

(51) Int. Cl. E06B 3/46; E05B 65/08

(52) U.S. Cl. 49/449; 49/404

(57) ABSTRACT

This is a design for a sliding glass door that provides the option to choose an opening right to left, or change to an opening left to right at anytime. The outside panel of the door can slide to either end of the opening and lock into place. The inside panel, sliding can slide to either end of the opening.

### CROSS-REFERENCE TO RELATED APPLICATIONS

Not Applicable.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable.

### BACKGROUND OF THE INVENTION

This invention relates to the design for the manufacture of sliding glass doors that are used in building, including but not limited to private homes, apartments and commercial building.

Currently, sliding glass doors are manufactured with one half of the door fixed (the outside panel) and one half of the door (inside panel) sliding. There is a choice for a door that opens either right to left or left to right. The choice must be made prior to installation and once chosen, the door is installed to permanently open right to left or left to right. If the opposite opening is desired; the sliding glass door must replaced. This invention provides the design to allow the doorway opening right to left to change to a doorway opening left to right at anytime. This ability to change the access to a room will allow greater flexibility in furniture or equipment arrangements in the room.

### BRIEF SUMMARY OF THE INVENTION

The sliding door frame has three tracks, one for the outside panel and one for the inside (door) panel and one on the outside for a screen door. The outside panel can slide to either side of the opening and lock into place. The inside panel can slide from either end of the door frame to open and close for door access to the room or building. The screen door can slide to either end of the opening.

### BRIEF DESCRIPTION OF THE SEVERAL VIEWS OF THE DRAWINGS

FIG. 1: A cut out view for example of the three tracks that make up the top and bottom of the frame.

FIG. 2: An inside view of the outer panel. The locks shown on the top and bottom are deadbolt type locks. The bolt locks into the opening in the frame. And on the left side the lock hooks onto the frame of the doorway.

FIG. 3: The cap fits on the exposed end of the outside panel to provide a smooth finish. The outside panel has weather stripping on both ends to provide a seal when the panel is locked into place. The cap covers the weather stripping on the exposed end of the panel.

FIG. 4: The inside panel, sliding door has handles on both sides. In this example the door opens right to left. The handle on the right locks to the door frame to lock in the closed position.

FIG. 5: The left handle locks to the cap that fits over the exposed end of the door.

FIG. 6: This shows the insert that covers the open track for the outside panel. When inserted into the track, it provides a cover and smoother finish for the outside track. The cap for the end of the outside panel is attached after the insert is placed and when locked in place, locks the insert in place as well.

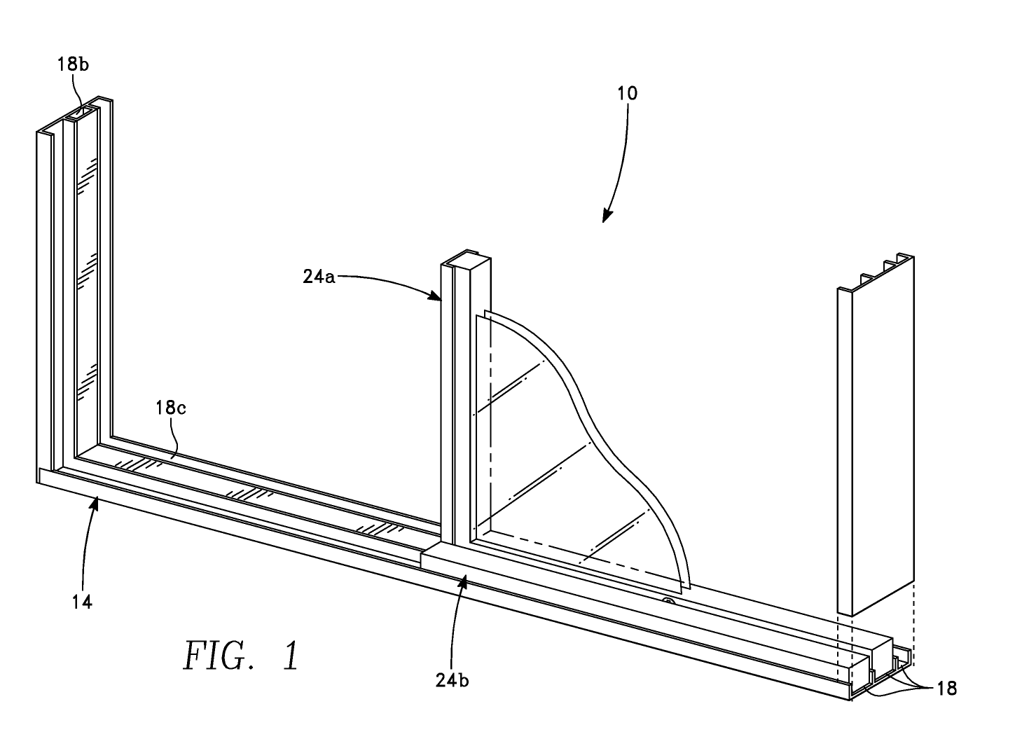

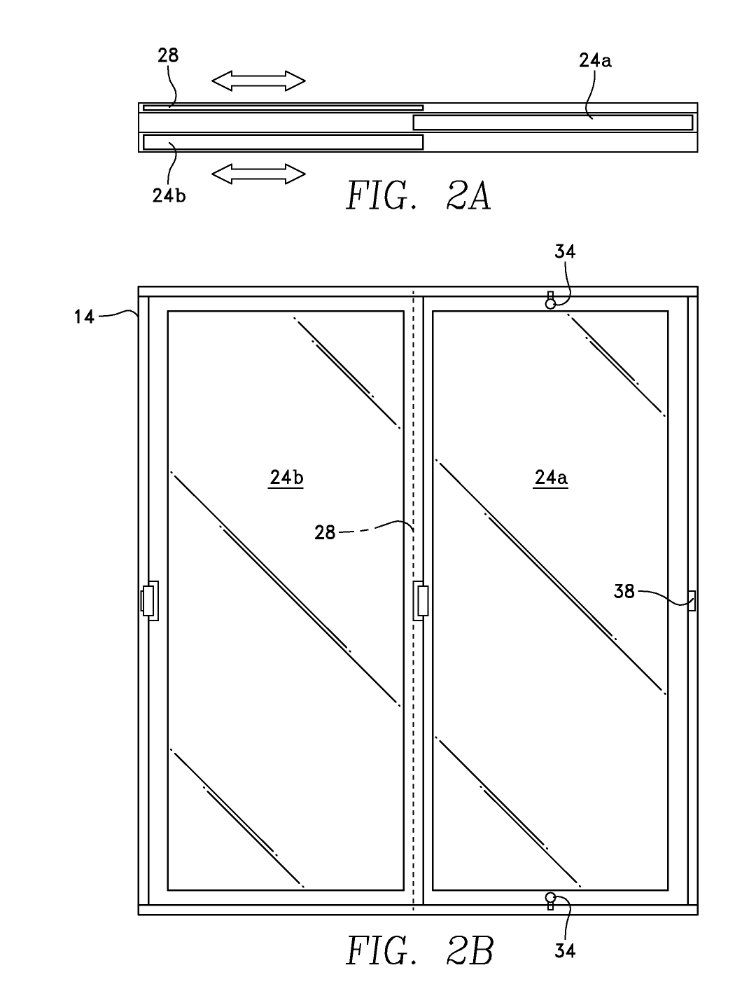

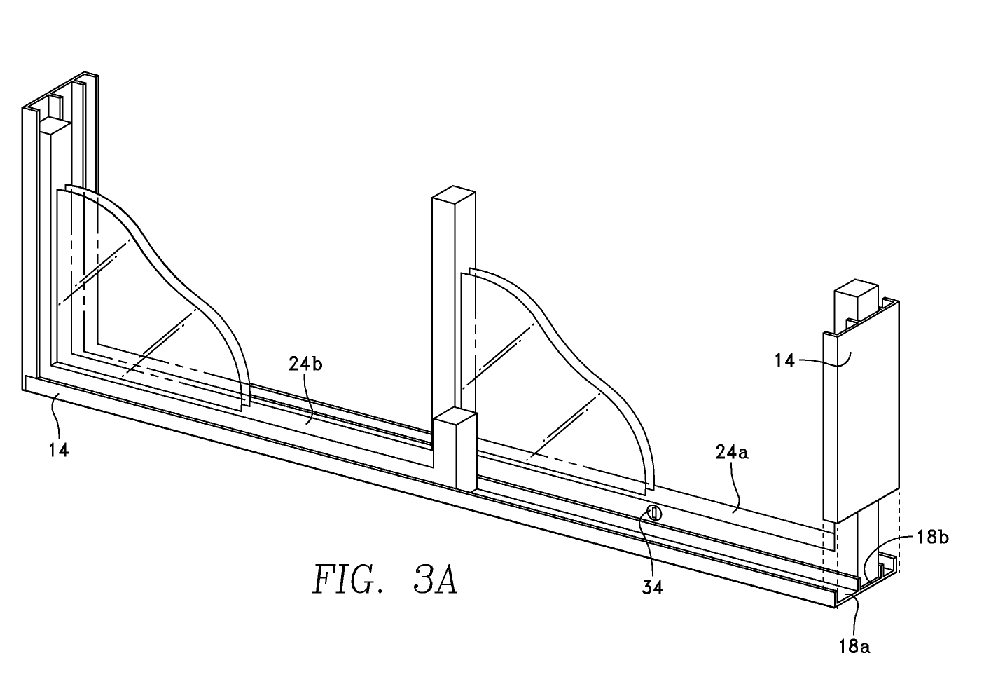

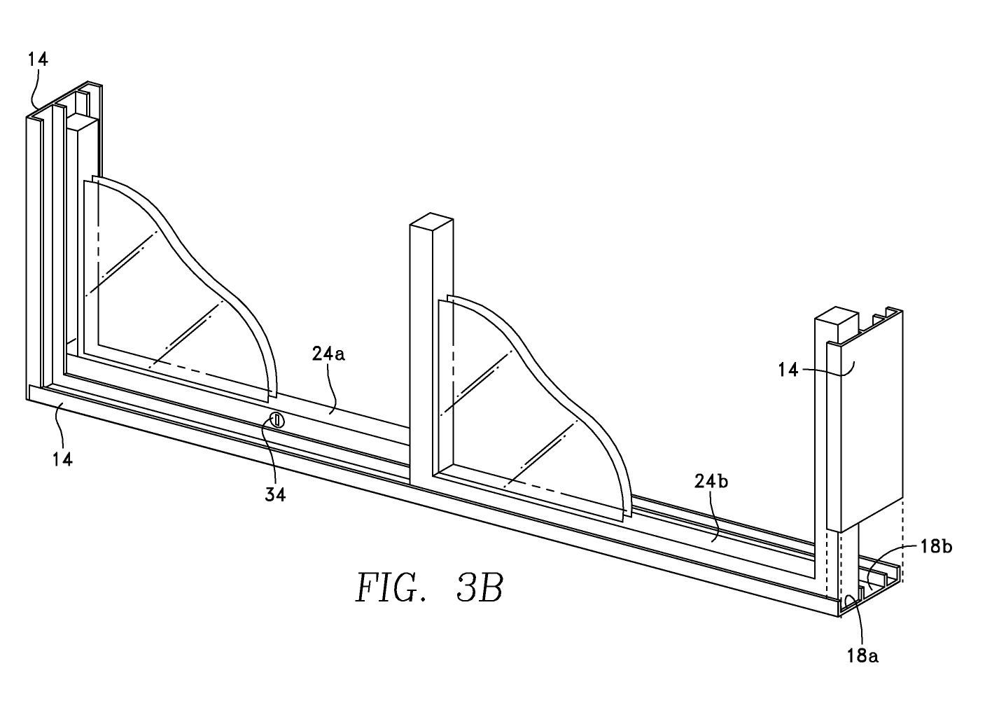

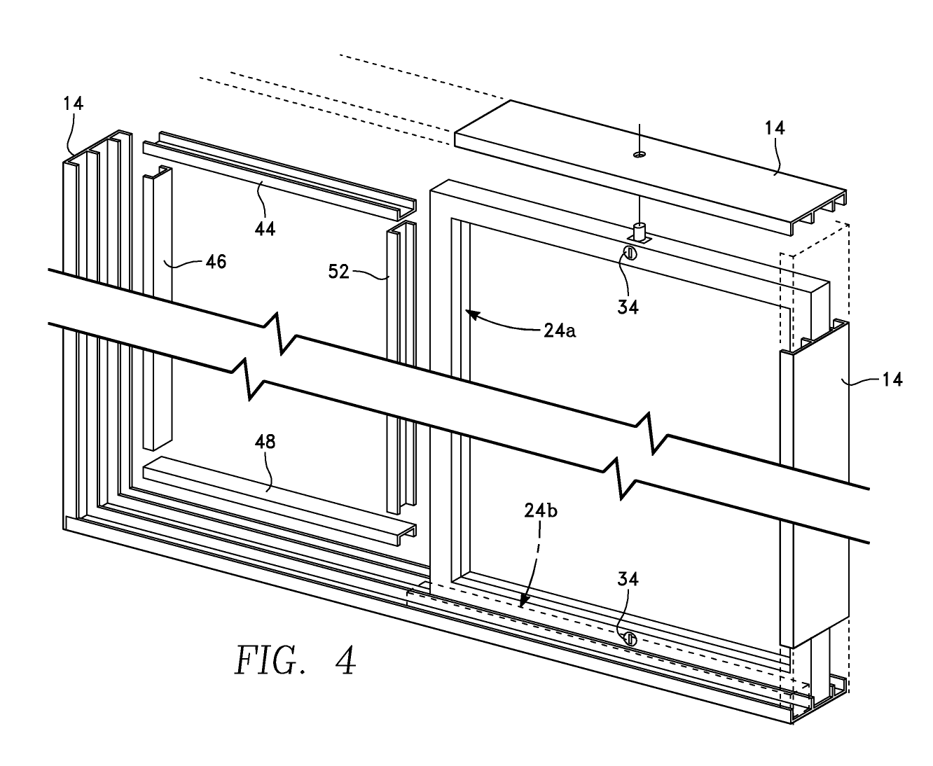

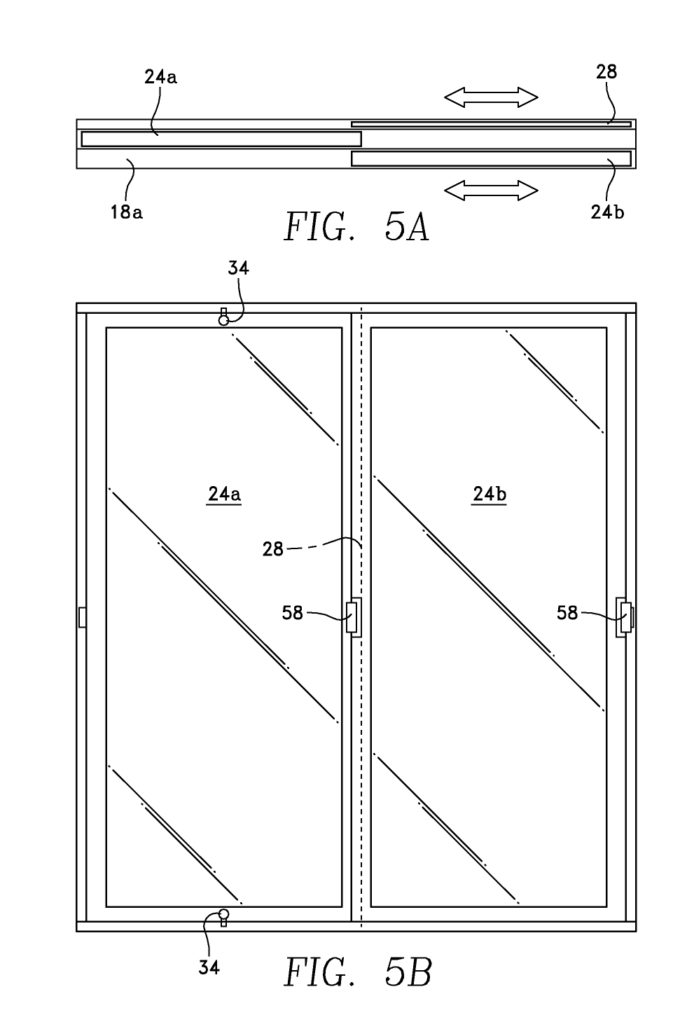

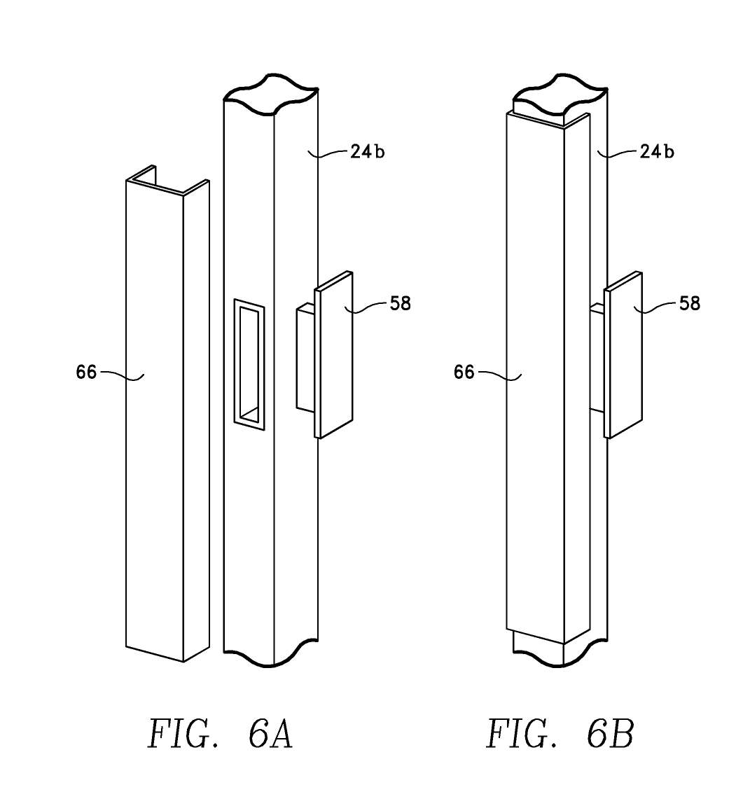

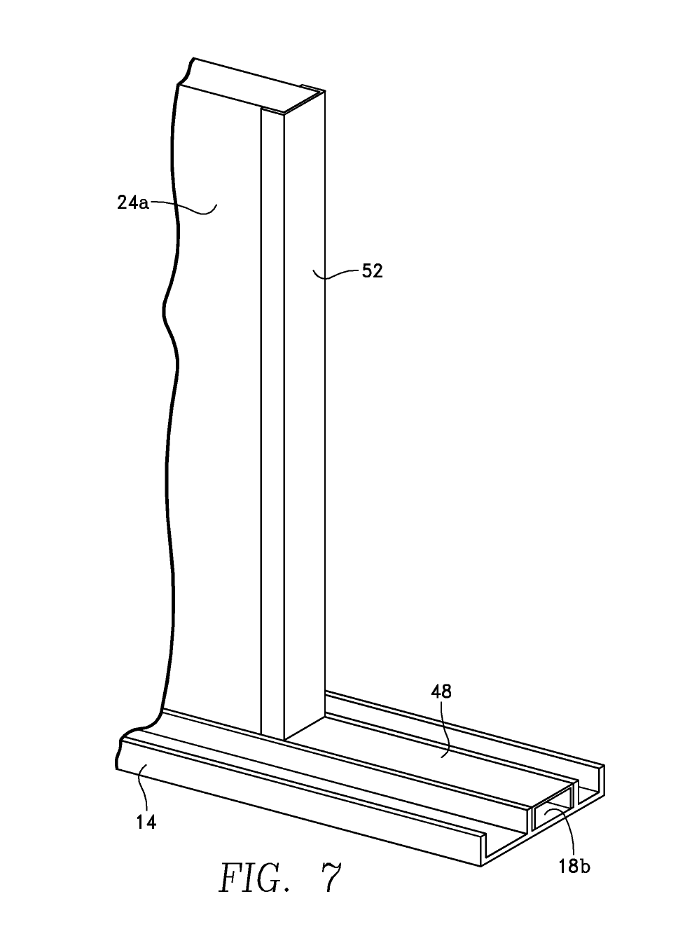

### DETAILED DESCRIPTION OF THE INVENTION

The sliding glass door is comprised of a frame with tracks that hold two panels, each cover half of the opening, there is an additional outside track for the sliding screen door.

The outer panel slides on the outside track and locks in place at either end of the opening to provide the security and support of the fixed portion of the sliding glass door assembly. The panel locks to the door frame on the top, bottom and side. The top and bottom locks can be either deadbolt type locks or clamp type locks as would be dictated by the construction material. For example, a deadbolt type lock would work better in a door manufactured in wood, a clamp type lock may work better in an aluminum door. The lock assembly is flush with the inside surface of the panel so as not to obstruct the sliding of the inside door panel. The lock on the side of the panel clamps or hooks to the frame to the secure the panel in position. The locks are the same on each side of the door frame.

Inserts cover the outside track to provide a finished, level surface for the open half of the door frame and also add to the security of the “fixed” portion of the sliding glass door. The insert consists of four (4) sections that may be separate pieces or connected. The sections insert into the top, side and bottom track openings (sections 1-3). The insert for sections 1-3 is U-shaped to fit inside and fill the track. Section 4 is a U-shaped cap that fits over the exposed end of the outer panel. On the inside of the U there is a latch that the locks with the lock on the side of the panel. When the cap is on the end of the panel, it overlaps the end of the insert for the top and bottom track inserts. The lock on the sides of the panel latch to the door frame on one side and lock to the insert on the other side, depending on the right or left opening that is chosen.

The inside panel, the sliding glass door, slides on the inside track. On the inside, the door has a handle and lock assembly on both sides. The handles on the outside of the door panel are indented for a flush surface on the outside of the panel to allow the door to slide past the outside panel. When the door opens right to left; the handle on the right, locks to the door frame to lock the door closed; and the handle on the left locks onto a cap for the end of the door panel. When the door opens left to right; the handle on the left, locks to the door frame to lock the door closed; and the handle on the right locks onto the cap for the end of the door panel.

The cap for the end of the panel is reversible to provide a finished edge to the exposed end of the door. The cap extends of the end of the door the same distance that the door closes into the door frame to close and seal. The weather strip that is on the inside of the door that seals it when closed into the door fame, also seals into the cap.

1. (canceled)

2. A sliding glass door assembly comprising:
an outer frame of substantially rectangular configuration defining a top extension, a bottom extension, and a pair of lateral extensions, said outer frame having at least two door tracks formed in an interior surface thereof;
an inner door panel slidably received within an inner track formed in said outer frame, said inner door frame including a handle and lock assembly, said lock assembly selectively engagable with said outer frame; and
an outer door panel slidably received within an outer track formed in said outer frame, said outer door panel including a track lock selectively engagable with said outer frame in a manner obtaining a fixed lateral position of said outer door panel within said outer track,
whereby the selective alternate engagement of said outer door panel adjacent each of said lateral extensions of said outer frame and the cooperative lateral alignment of said inner door panel define alternative lateral openings through said sliding glass door assembly.

3. The sliding glass door assembly of claim 2, and further comprising a plurality of inserts selectively receivable in said top, bottom, and one of said lateral extensions of said outer track upon the engagement of said track lock and positioning of said outer door panel adjacent said other lateral extension of said outer frame.

4. The sliding glass door assembly of claim 2, wherein said inner door panel includes a pair of handle and lock assemblies, one of said handle and lock assemblies adjacent each lateral edge of said door panel, each of said lock assemblies selectively engagable with a separate one of said pair of lateral extensions of said outer frame.

5. The sliding glass door assembly of claim 4, and further comprising a door end cap selectively engagable with one of said pair of lock assemblies on said inner door panel.

6. A sliding closure assembly comprising:
a frame receivable within a building opening, said frame of rectangular construction having a top and a bottom extension attached to a pair of lateral extensions and wherein a plurality of door tracks are formed in an interior surface of said frame, said door tracks extending substantially continuously about said interior surface of said frame;
an inner door panel received within a first of said plurality of door tracks and alternatively slidably engaging with each of said pair of lateral extensions of said frame through lateral movement of said inner door panel along said top and bottom extensions of said frame; and
an outer door panel received within a second of said plurality of door tracks and slidably engaging with said frame at locations placing a lateral edge of said outer door panel adjacent a selective one of said pair of lateral extensions of said frame,
whereby selective engagement of said outer door panel to said frame adjacent selective ones of said lateral extensions define selective alternate through-frame passages upon cooperative lateral alignment of said inner door panel within said first door track and with said outer door panel within said second door track.

7. The sliding closure assembly of claim 6, wherein said inner door panel is of substantially rectangular construction and includes a handle and lock assembly adjacent each lateral side of said inner door panel.

8. The sliding closure assembly of claim 7, wherein said outer door panel is of substantially rectangular construction and includes at least one track lock selectively engageable with said frame.

9. The sliding closure assembly of claim 8, wherein said outer door panel includes a pair of track locks, a first track lock selectively engagable with said bottom extension of said frame and a second track lock selectively engageable with a top extension of said frame.

10. The sliding closure assembly of claim 9, and further comprising a plurality of inserts selectively receivable in said top, bottom, and one of said lateral extensions of said outer track upon the engagement of said track lock and positioning of said outer door panel adjacent said other lateral extension of said outer frame.

11. The sliding closure assembly of claim 10, and further comprising a door end cap selectively engagable with one of said pair of lock assemblies on said inner door panel.

12. The sliding closure assembly of claim 6, wherein said sliding closure assembly is a sliding glass door, and wherein a third door track is provided and further comprising a screen door slidably received within said third door track.
